(19) United States
(12) Patent Application Publication
(10) Pub. No.: US 2003/0062706 A1
(43) Pub. Date: Apr. 3, 2003

(54) Bike buddy

(76) Inventor: Aaron Land, Lakewood, CA (US)

Correspondence Address: Matthew J. Peirce, Esq., 1550 Starlight Canyon Avenue, Las Vegas, NV, 89123, US

(21) Appl. No.: 09/967,276

(22) Filed: Oct. 1, 2001

(51) Int. Cl. B62H 1/00

(52) U.S. Cl. 280/301; 248/346.01

(57) ABSTRACT

A motorcycle support apparatus is disclosed to properly prop up a motorcycle when the motorcycle is not in use. The apparatus, in its preferred embodiment, would be a circular dish approximately three (3) inches in diameter and approximately one-eighth (⅛) inch thick. The apparatus would preferably be made from aluminum 5052 or aluminum 6061. The apparatus would be carried around in a motorcycle rider's pocket and taken out when needed by placing it under the kickstand of a motorcycle when parking the motorcycle on semi-soft surfaces such as asphalt, grass, dirt, sand, or other soft surfaces. The present invention would stop the kickstand from sinking into the soft ground and causing the motorcycle to topple over. An alternative embodiment of the apparatus would be in the shape of an oval-shaped support stand that would be approximately six inches in diameter at it's widest point and between three to four inches at it's narrowest point.

### BACKGROUND OF THE INVENTION

The present invention concerns that of a new and improved apparatus used to properly prop a motorcycle on a soft ground surface when the motorcycle is not in use.

### DESCRIPTION OF THE PRIOR ART

U.S. Pat. No. 4,521,031, issued to Huth, discloses a support pad or standpad for maintaining a two-wheeled vehicle having a kickstand in the upright position when placed between the two-wheeled vehicle kickstand and a soft supporting surface.

U.S. Pat. No. 3,970,330, issued to Norcross, discloses a removable foot adapted to friction fit on the ground-contacting shank of a conventional cycle kickstand which has a base with a top surface from which a sleeve projects, and a sole that is larger than the ground end of the kickstand.

U.S. Pat. No. 3,955,829, issued to Bussler, discloses a pad intended to be affixed to the lower end of a conventional bicycle kickstand and adapted to engage the ground when the kickstand is in the operative position extending downward and outwardly from the bicycle on which it is mounted.

### SUMMARY OF THE INVENTION

The present invention is that of an apparatus used to properly prop up a motorcycle when the motorcycle is not in use. The apparatus, in its preferred embodiment, would be a circular dish approximately three (3) inches in diameter and approximately one-eighth (⅛) inch thick. The apparatus would preferably be made from aluminum 5052 or aluminum 6061. The apparatus would be carried around in a motorcycle rider's pocket and taken out when needed by placing it under the kickstand of a motorcycle when parking the motorcycle on semi-soft surfaces such as asphalt, grass, dirt, sand, or other soft surfaces. The present invention would stop the kickstand from sinking into the soft ground and causing the motorcycle to topple over. After use, the present invention would be placed back into the pocket of a motorcycle user.

An alternative embodiment of the present invention would be an oval-shaped support stand that would be approximately six inches in diameter at it's widest point and between three to four inches at it's narrowest point. The apparatus would be carried around in a motorcycle rider's pocket and taken out when needed by placing it under the kickstand of a motorcycle when parking the motorcycle on semi-soft surfaces such as asphalt, grass, dirt, sand, or other soft surfaces. The present invention would stop the kickstand from sinking into the soft ground and causing the motorcycle to topple over. After use, the present invention would be placed back into the pocket of a motorcycle user.

There has thus been outlined, rather broadly, the more important features of a motorcycle support apparatus in order that the detailed description thereof that follows may be better understood and in order that the present contribution to the art may be better appreciated. There are, of course, additional features of the motorcycle support apparatus that will be described hereinafter and which will form the subject matter of the claims appended hereto.

In this respect, before explaining at least one embodiment of the motorcycle support apparatus in detail, it is to be understood that the motorcycle support apparatus is not limited in its application to the details of construction and to the arrangements of the components set forth in the following description or illustrated in the drawings. The motorcycle support apparatus is capable of other embodiments and being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present motorcycle support apparatus. It is important, therefore, that the claims be regarded as including such equivalent constructions insofar as they do not depart front the spirit and scope of the present invention.

It is therefore an object of the present invention to provide a motorcycle support apparatus which has all of the advantages of the prior art and none of the disadvantages.

It is another object of the present invention to provide a motorcycle support apparatus which may be easily and efficiently manufactured and marketed.

It is another object of the present invention to provide a motorcycle support apparatus which is of durable and reliable construction.

It is yet another object of the present invention to provide a motorcycle support apparatus which is economically affordable and available for relevant purchasing government entities.

Other objects, features and advantages of the present invention will become more readily apparent from the following detailed description of the preferred embodiment when considered with the attached drawings and appended claims.

### BRIEF DESCRIPTION OF THE DRAWINGS

FIG. 1 shows a side view of a motorcycle using the present invention.

FIG. 2 shows a top view of the present invention.

FIG. 3 shows a top view of the alternative embodiment of the present invention.

### DESCRIPTION OF THE PREFERRED EMBODIMENT

Referring now to FIG. 1, motorcycle 2 is shown with wheels 8 and 10. Motorcycle 2 is supported by kickstand 4, which is shown in a down or supporting position.

If motorcycle 2 was on a soft surface, and kickstand 4 was placed in a down position, the weight of motorcycle 2 would likely force kickstand 4 into the ground, thereby causing motorcycle 2 to lean over at an extreme angle and possibly cause motorcycle 2 to fall over. As motorcycles tend to generally be fairly heavy, falls of motorcycles are not desirable because they tend to damage motorcycles to varying degrees.

In FIG. 1, kickstand 4 is shown being supported by plate 6. To effectively use 6, kickstand 4 should be placed on top of plate 6 roughly in the center of plate 6 when motorcycle 2 is being left on a soft surface. Care should be maintained to ensure that plate 6 is placed flat on the relevant soft surface, or else, kickstand 4 may slide off of plate 6, thereby defeating the purpose of the use of the present invention and plate 6.

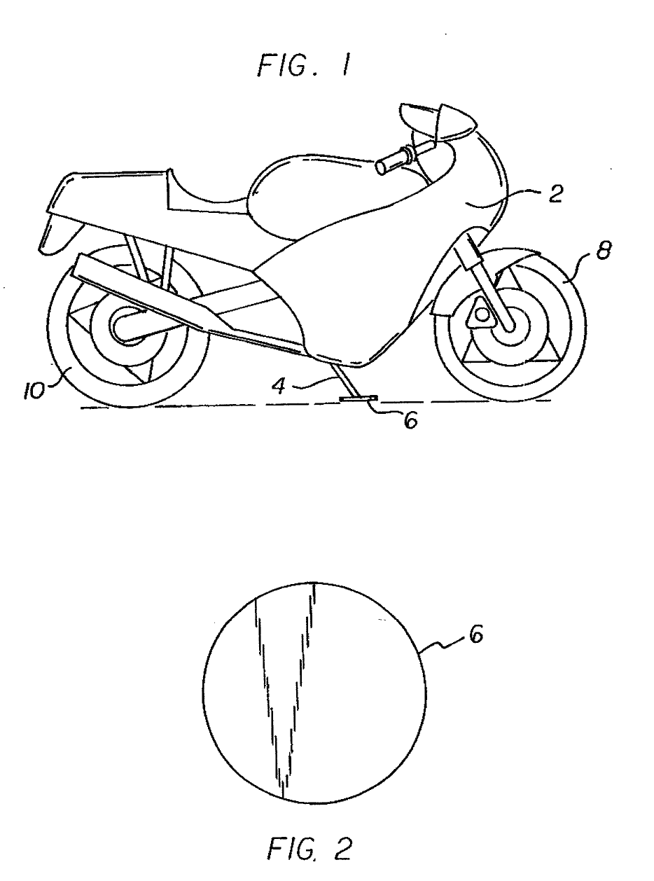

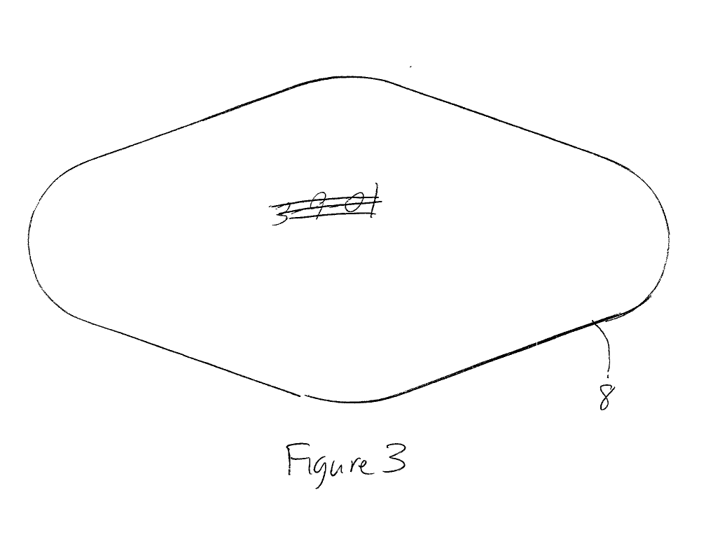

FIG. 2 shows a close-up top view of plate 6. Preferably, plate 6 is a circular disk approximately three (3) inches in diameter and approximately one-eighth (⅛) inch thick. Plate 6 would preferably be made from aluminum 5052 or aluminum 6061, but could be made from other metals as well.

FIG. 3 shows a close-up top view of alternative plate 8. Preferably, plate 8 is an oval-shaped support stand that would be approximately six inches in diameter at it's widest point and between three to four inches at it's narrowest point and approximately one-eighth (⅛) inch thick. Like plate 6, plate 8 would preferably be made from aluminum 5052 or aluminum 6061, but could be made from other metals as well.

What I claim as my invention is:

1. A motorcycle support apparatus comprising a circular disc approximately three inches in diameter, the dish having a thickness of approximately one-eighth (⅛) inch, the circular dish preferably being fabricated from metal.

2. A motorcycle support apparatus according to claim 1 wherein the metal located within the circular dish would preferably be aluminum.

3. A motorcycle support apparatus according to claim 2 wherein the aluminum located within the circular dish would preferably comprise either aluminum 5052 or aluminum 6061.

4. A motorcycle support apparatus according to claim 3 in combination with a motorcycle, the motorcycle including a kickstand, wherein a user would place the motorcycle support apparatus on a soft surface normally inappropriate for placement of a kickstand support a motorcycle, wherein a user would park his or her motorcycle on the soft surface, wherein a user would lower their kickstand, the kickstand having two ends, a first end and a second end, the first end of the kickstand being pivotally attached to the motorcycle, wherein a user would place the second end of the kickstand on top of the motorcycle support apparatus.

5. A motorcycle support apparatus comprising a oval-shaped support stand that would be approximately six inches in diameter at it's widest point and between three to four inches at it's narrowest point, the stand having a thickness of approximately one-eighth (⅛) inch, the stand preferably being fabricated from metal.

6. A motorcycle support apparatus according to claim 5 wherein the metal located within the circular dish would preferably be aluminum.

7. A motorcycle support apparatus according to claim 6 wherein the aluminum located within the circular dish would preferably comprise either aluminum 5052 or aluminum 6061.

8. A motorcycle support apparatus according to claim 7 in combination with a motorcycle, the motorcycle including a kickstand, wherein a user would place the motorcycle support apparatus on a soft surface normally inappropriate for placement of a kickstand support a motorcycle, wherein a user would park his or her motorcycle on the soft surface, wherein a user would lower their kickstand, the kickstand having two ends, a first end and a second end, the first end of the kickstand being pivotally attached to the motorcycle, wherein a user would place the second end of the kickstand on top of the motorcycle support apparatus.
